(19) United States
(12) Patent Application Publication
(10) Pub. No.: US 2003/0126622 A1
(43) Pub. Date: Jul. 3, 2003

(54) Method for efficiently storing the trajectory of tracked objects in video

(75) Inventors: Robert A. Cohen, Troy, NY (US); Tomas Brodsky, Croton on Hudson, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/029,730

(22) Filed: Dec. 27, 2001

(51) Int. Cl. H04N 7/173; H04N 7/16; H04N 7/00; H04N 11/00; H04N 5/445; H04N 9/76

(52) U.S. Cl. 725/135; 348/461; 725/90; 348/563; 348/598

(57) ABSTRACT

A process and system for enhanced storage of trajectories reduces storage requirements over conventional methods and systems. A video content analysis module automatically identifies objects in a video frame, and determines the (xᵢ,yᵢ) coordinates of each object i. The reference coordinates for each for object i, (xrefᵢ,yrefᵢ) are set to (xᵢ,yᵢ) when the object is first identified. For subsequent frames, if the new coordinates (xnewᵢ,ynewᵢ) are less than a given distance from the reference coordinates, that is if ∥(xnewᵢ,ynewᵢ)−(xref₁,yrefᵢ)∥²<ε, then the current coordinates are ignored. However, if the object moves more than the distance ε, the current coordinates (xnewᵢ,ynewᵢ) are stored in the object's trajectory list, and we set the reference coordinates (xref₁,yrefᵢ) to the object's current position. This process is repeated for all subsequent video frames. The resulting compact trajectory lists can then be written to memory or disk while they are being generated, or when they are complete.

### BACKGROUND OF THE INVENTION

1. Field of the Invention

The present invention relates to the tracking of objects in video sequences. More particularly, the present invention relates to storage of coordinates used to track object trajectories.

2. Description of the Related Art

In the prior art, when objects are tracked in a video sequence, trajectory coordinates are typically generated for each frame of video. Considering that, for example, that under the NTSC standard, which generates 30 frames per second, a new location or coordinate for each object in a video sequence must be generated and stored for each frame.

This process is extremely inefficient and requires tremendous amounts of storage. For example, if five objects in a video sequence were tracked, over two megabytes of storage would be needed just to store the trajectory data for a single hour. Thus, storage of all of the trajectories is expensive, if not impractical.

There have been attempts to overcome the inefficiency of the prior art. For example, in order to save space, the coordinates for every video frame have been compressed. One drawback is that the compression of the trajectories introduces delay into the process. Regardless of the compression, there is still a generation of coordinates for each frame. In addition, there has been an attempt to circumvent the generation of trajectories by devices that store the location of motion in video for every frame, based on a grid-based breakup of the video frame. These devices still store data for each frame, and the accuracy of the location of motion is not comparable to the generation of trajectories.

### SUMMARY OF THE INVENTION

Accordingly, it is an object of the present invention to provide a method and system that addresses the shortcomings of the prior art.

In a first aspect of the present invention, the coordinates are stored only when objects move more than a predetermined amount, rather than storing their movement after every frame.

This feature permits a tremendous savings in memory or disk usage over conventional methods. In addition, the need to generate coordinates can be greatly reduced to fractions of the generation per frame that is conventionally processed.

A video content analysis module automatically identifies objects in a video frame, and determines the (xᵢ,yᵢ) coordinates of each object i. The reference coordinates for each for object i, (xrefᵢ,yrefᵢ) are set to (xᵢ,yᵢ) when the object is first identified. For subsequent frames, if the new coordinates (xnewᵢ,ynewᵢ) are less than a given distance from the reference coordinates, that is if ∥(xnewᵢ,ynewᵢ)−(xrefᵢ,yrefᵢ)∥²<ε, then the current coordinates are ignored. However, if the object moves more than the distance e, the current coordinates (xnewᵢ,ynewᵢ) are stored in the object's trajectory list, and we set the reference coordinates (xrefᵢ,yrefᵢ) to the object's current position. This process is repeated for all subsequent video frames. The resulting compact trajectory lists can then be written to memory or disk while they are being generated, or when they are complete.

The present invention can be used in many areas, including video surveillance security system that tracks movement in a particular area, such as a shopping mall, etc. The amount of storage conventionally required for standard video cameras that scan/videotape an area, such a VCR, often creates a huge unwanted library of tapes. In addition, there is a tendency to reuse the tapes quickly so as not to set aside tape storage areas, or pay for their shipment elsewhere. The compact storage of the present invention makes the permanent storage of secure areas much more practical, and provides a record to investigators to see whether a particular place was “cased” (e.g. observed by a wrongdoer prior to committing an unlawful act) by a wrongdoer prior to a subsequent unlawful action being performed.

Also, in a commercial setting, the present invention could be applied to track people in, for example, a retail store to see how long they waited on the checkout line.

Accordingly, a method for storing a trajectory of tracked objects in a video, comprising the steps of:

(a) identifying objects in a first video frame;

(b) determining first reference coordinates (xrefᵢ,yrefᵢ) for each of said objects identified in step (a) in the first video frame;

(c) storing the first reference coordinates (xrefᵢ,yrefᵢ);

(d) identifying said objects in a second video frame;

(e) determining current reference coordinates (xnewᵢynewᵢ) of said objects in said second video frame; and

(f) storing the current reference coordinates of a particular object in an object trajectory list and replacing the first reference coordinates (xrefᵢ,yrefᵢ) with the current reference coordinates (xnewᵢ,ynewᵢ) if the following condition for the particular object is satisfied:

∥(xnewᵢ,ynewᵢ)−(xrefᵢ,yrefᵢ)∥²≧ε,

wherein ε is a predetermined threshold amount, and

retaining the first reference coordinates (xrefᵢ,yrefᵢ) for comparison with subsequent video frames when said condition in step (f) is not satisfied.

The method according may further comprise (g) repeating steps (e) and (f) for all video frames subsequent to said second video frame in a video sequence so as to update the storage area with additional coordinates and to update the current reference coordinates with new values each time said condition in step (f) is satisfied.

Optionally, the method may include a step of storing the last coordinates of the object (i.e., the coordinates just before the object disappears and the trajectory ends), even if the last coordinate does not satisfy condition (f).

The object trajectory list for the particular object stored in step (f) may comprise a temporary memory of a processor, and

the method may optionally include the following step:

(h) writing the object trajectory list to permanent storage from all the coordinates stored in the temporary memory after all the frames of the video sequence have been processed by steps (a) to (g).

The permanent storage referred to in step (h) may comprise at least one of a magnetic disk, optical disk, and magneto-optical disk, or even tape. Alternatively, the permanent storage can be arranged in a network server.

The determination of the current reference coordinates (x_{1new}y_{inew}) in step (e) can include size tracking of the objects moving one of (i) substantially directly toward, and (ii) substantially directly away from a camera by using a box bounding technique. The box bounding technique may comprise:

(i) determining a reference bounding box (wrefᵢ,hrefᵢ) of the particular object i, wherein w represents a width, and h represents a height of the particular object;

(ii) storing a current bounding box (wᵢ,hᵢ) if either of the following conditions in substeps (ii) (a) and (ii) (b) are satisfied:

|wᵢ−wrefᵢ|>δ_{w}; (ii) (a)

|hᵢ−hrefᵢ|>δₕ, (ii) (b)

where δ_{w} and δₕ are predetermined thresholds.

Alternatively, the box bounding technique may comprise:

(i) determining an area arefᵢ=wrefᵢ*hrefᵢ of a reference bounding box (wrefᵢ,hrefᵢ) of the particular object, wherein w represents a width, and h represents a height of the particular object; and

(ii) storing coordinates of a current bounding box (wᵢ,hᵢ) if a change in area δₐ=|aref_{I}−wᵢ*hᵢ| of the current bounding box is greater than a predetermined amount.

### BRIEF DESCRIPTION OF THE DRAWINGS

FIGS. 1A-1C illustrate a first aspect of the present invention wherein the motion in FIG. 1B relative to FIG. 1A fails to satisfy the expression in FIG. 1C.

FIGS. 2A-2C illustrate a second aspect of the present invention wherein the motion in FIG. 2B relative to FIG. 2A satisfies the expression in FIG. 1C.

FIGS. 3A-3C illustrate another aspect of the present invention pertaining to a box bounding technique.

FIG. 4 illustrates a schematic of a system used according to the present invention.

FIGS. 5A and 5B are a flow chart; illustrating an aspect of the present invention.

### DETAILED DESCRIPTION OF THE PREFERRED EMBODIMENTS

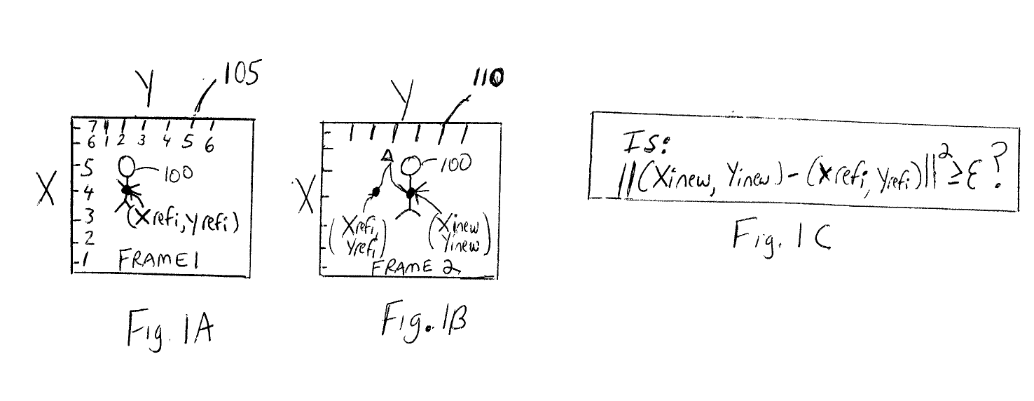

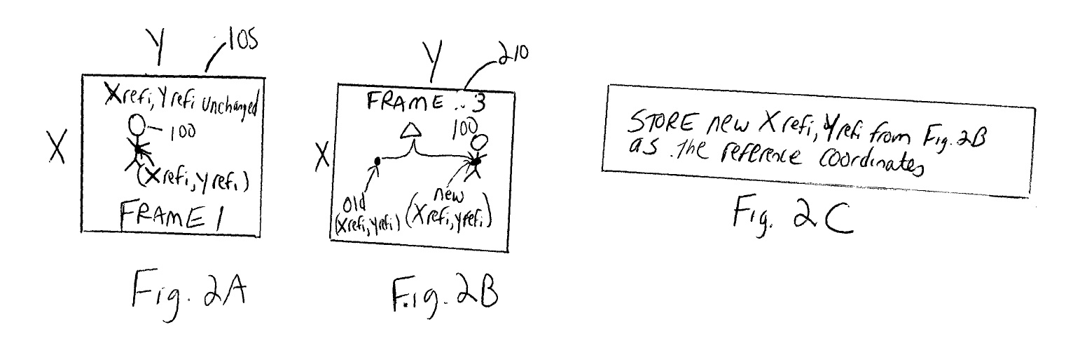

FIGS. 1A-1C illustrate a first aspect of the present invention. As shown in FIG. 1A a frame 105 contains an object 100 (in this case a stick figure representing a person). To aid in understanding, numerical scales in both the X direction and Y direction have been added to the frame. It is noted that the x,y coordinates can be obtained, for example, by using the center of the mass of the object pixels, or in the case of a bounding box technique (which is disclosed, infra) by using the center of the object bounding box.

It should be understood by persons of ordinary skill in the art that the scales are merely for illustrative purposes, and the spaces there between, and/or the number values do not limit the claimed invention to the scale. The object 100 is identified at a position (xrefᵢ,yrefᵢ) which are now used as the x and y reference point for this particular object.

It should be noted that the objects identified do not have to be, for example, persons, and could include inanimate objects in the room, such as tables, chairs, and desks. As known in the art, these objects could be identified by, for example, their color, shape, size, etc. Preferably, a background subtraction technique is used to separate moving objects from the background. One way this technique is used is by learning the appearance of the background scene and then identifying image pixels that differ from the learned background. Such pixels typically correspond to foreground objects. Applicants hereby incorporate by reference as background material the articles by A. Elgammal, D. Harwood, and L. Davis, “Non-parametric Model for Background Subtraction”, Proc. European Conf. on Computer vision, pp. II: 751-767, 2000, and C. Stauffer, W. E. L. Grimson, “Adaptive Background Mixture Models for Real-time Tracking”, Proc. Computer Vision and Pattern Recognition, pp. 246-252, 1999 as providing reference material for some of the methods that an artisan can provide object identification. In the Stauffer reference, simple tracking links objects in successive frames based on distance, by marking each object in the new frame by the same number as the closest object in the previous frame. Additionally, the objects can be identified by grouping the foreground pixels, for example, by a conected-components algorithm, as described by T. Cormen, C. Leiserson, R. Rivest, “Introduction to Algorithms”, MIT Press, 1990, chapter 22.1, which is hereby incorporated by reference as background material. Finally, the objects can be tracked such as disclosed in U.S. patent application Ser. No. ______ entitled “Computer Vision Method and System for Blob-Based Analysis Using a Probabilistic Network, U.S. Ser. No. 09/988,946 filed Nov. 19, 2001, the contents of which are hereby incorporated by reference.

Alternatively, the objects could be identified manually. As shown in FIG. 1B, object 100 has moved to a new position captured in the second frame 110 having coordinates of (xnewᵢ,ynewᵢ) which is a distance away from the (xrefᵢ,yrefᵢ) of the first frame 105.

It is appreciated by an artisan that while there are many ways that objects can be identified and tracked, the present invention is applicable regardless of the specific type of identification and tracking of the objects. The amount of savings in storage is significant irrespective of the type of identification and tracking.

According to an aspect of the present invention, rather than storing new coordinates for every object and every frame, an algorithm determines whether or not the movement by object 100 in the second frame is greater than a certain predetermined amount. In the case where the movement is less than the predetermined amount, coordinates for FIG. 1B are not stored. The reference coordinates identified in the first frame 105 continue to be used against a subsequent frame.

FIG. 2A again illustrates, (for convenience of the reader), frame 105, whose coordinates will be used to track motion in a third frame 210. The amount of movement by the object 100 in the third frame, as opposed to its position in the first frame 105, is greater than the predetermined threshold. Accordingly, the coordinates of the object 100 in FIG. 2B now become the new reference coordinates (as identified in the drawing as new (xrefᵢ,yrefᵢ), versus the old (xrefᵢ,yrefᵢ). Accordingly, the trajectory of the object 100 includes the coordinates in frames 1 and 3, without the need to save the coordinates in frame 2. It should be understood that, for example, as standards such as NTSC generate 30 frames per second, the predetermined amount of movement could be set so that significant amounts of coordinates would not require storage. This process can permit an efficiency in compression heretofore unknown.

The amount of movement used as a predetermined threshold could be tailored for specific applications, and includes that the threshold can be dynamically computed, or modified during the analysis process. The dynamic computation can be based on factors such as average object velocity, general size of the object, importance of the object, or other statistics of the video.

For example, in a security film, very small amounts of motion could be used when items being tracked are extremely valuable, as opposed to larger threshold amounts permit more efficient storage, which can be an important consideration based on storage capacity and/or cost. In addition, the threshold amount can be application specific so that the trajectory of coordinates is as close to the actual movement as desired. In other words, if a threshold amount is too large, it could be movement in different directions that is not stored. Accordingly, the trajectory of the motion would be that between only the saved coordinates, which, of course, may not necessarily comprise the exact path that would be determined in the conventional tracking and storage for each individual frame. It should be noted that with many forms of compression, there normally is some degree of paring of the representation of the objects.

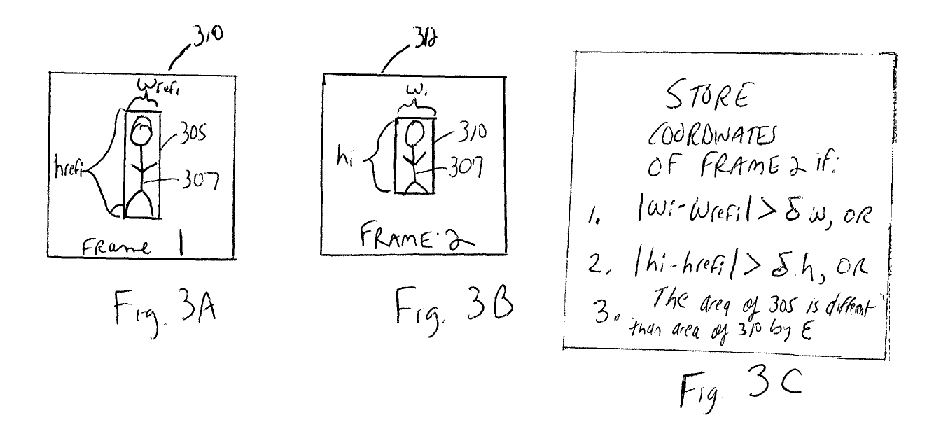

FIGS. 3A to 3C illustrate another aspect of the present invention pertaining to a box bounding technique. It is understood by persons of ordinary skill in the art that while a camera is depicted, the video image could be from a video server, DVD, videotape, etc. When objects move directly toward or away from a camera, their coordinates may not change enough to generate new trajectory coordinates for storage. A box bounding technique is one way that the problem can be overcome. For example, in the case of an object moving directly toward or away from the camera, the size of the object will appear to become larger or smaller depending on the relative direction.

FIGS. 3A to 3C illustrate a box bounding technique using size tracking. As shown in FIG. 3A, a bounding box 305 represents the width and height of an object 307 the first frame 310.

As shown in the second frame 312 in FIG. 3B, the bounding box in 310 of object 307 has changed (as these drawings are for explanatory purposes, they are not necessarily to scale).

As shown in FIG. 3C, the box bounding technique would store the coordinate of the object in the second frame 312 if the width of a bounding box in a subsequent frame is different from the width of the reference box of the previous frame, or the height of the bounding box in a particular frame is different from the height of the bounding box of a reference frame; in each case the difference is more than a predetermined threshold value. Alternatively, the area of the bounding box (width x height) could be used as well, so if the area of the bounding box 310 is different than the area of the reference bounding box 305 by a predetermined amount, the coordinates of the second frame would be stored.

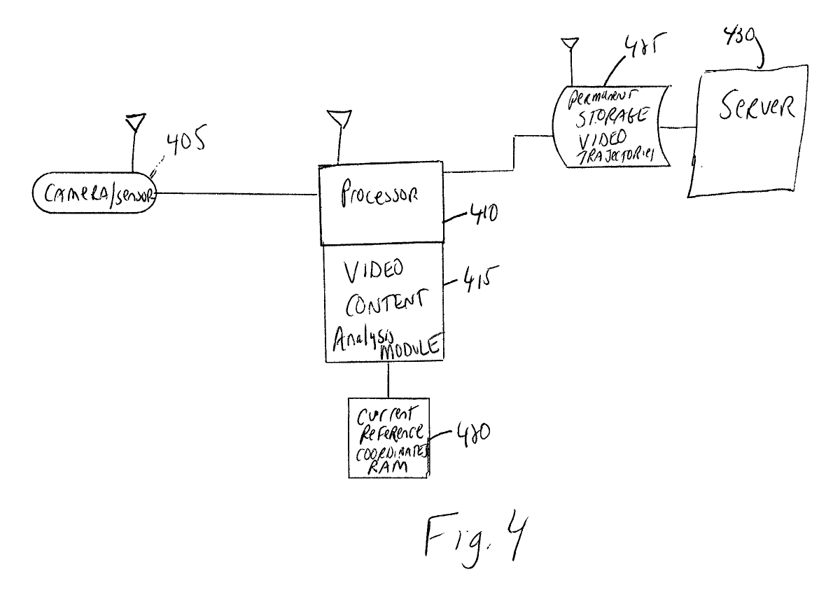

FIG. 4 illustrates one embodiment of a system according to the present invention. It should be understood that the connections between all of the elements could be any combination of wired, wireless, fiber optic, etc. In addition, some of the items could be connected via a network, including but not limited to the Internet. As shown in FIG. 4, a camera 405 captures images of a particular area and relays the information to a processor 410. The processor 410 includes a video content analysis module 415 which identifies objects in a video frame and determines the coordinates for each object. The current reference coordinates for each object could be stored, for example, in a RAM 420, but it should be understood that other types of memory could be used. As a trajectory is a path, the initial reference coordinates of the identified objects would also be stored in a permanent storage area 425. This permanent storage area could be a magnetic disc, optical disc, magneto optical disc, diskette, tape, etc. or any other type of storage. This storage could be located in the same unit as the processor 410 or it could be stored remotely. The storage could in fact be part of or accessed by a server 430. Each time the video content module determines that motion for an object in a frame exceeds the value of the reference coordinates by a predetermined threshold, the current reference coordinates in the RAM 420 would be updated as well as permanently stored 425. As the system contemplates only a storage of motion beyond a certain threshold amount, the need to provide storage or sufficient capacity to record every frame is reduced and in most cases, eliminated. It should also be noted that the storage could be video tape.

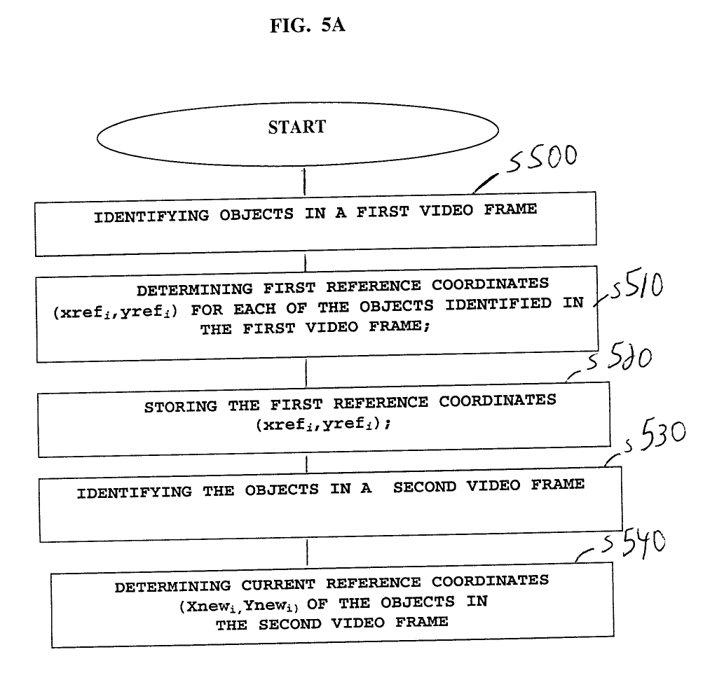

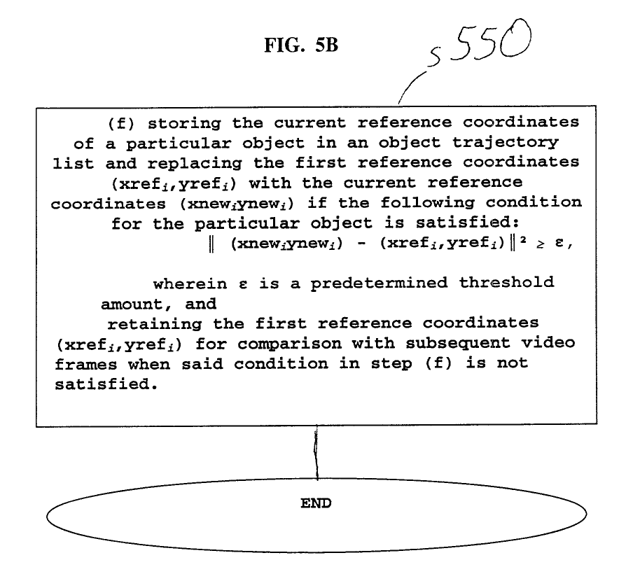

Applicants' FIGS. 5A and 5B illustrate a flow chart that provides an overview of the process of the present of the present invention.

At step 500, objects in the first video frame are identified.

At step 510, the reference coordinates for each of the objects identified in the first video frame are determined. The determination of these reference coordinates may be known by any known method, e.g., using the center of the object bounding box, or the center of mass of the object pixels.

At step 520, the first reference coordinates determined in step 10 are stored. Typically, these coordinates could be stored in a permanent type of memory that would record the trajectory of the object. However, it should be understood that the coordinates need not be stored after each step. In other words, the coordinates could be tracked by the processor in the table, and after all the frames have been processed, the trajectory could be stored at that time.

At step 530, the objects in the second video frame are identified.

At step 540, there is a determination of the current reference coordinates of the objects in the second video frame. These coordinates may or may not be the same as in the first frame. As shown in FIG. 5B, at step 550 the current reference coordinates of a particular object are stored in an object trajectory list and used to replace the first referenced coordinates of that particular object if the following condition for the particular object is satisfied ∥(xnewᵢ,ynewᵢ)−(xrefᵢ,yrefᵢ)∥²≧ε, However, when the condition is not satisfied, the first reference coordinates are retained for comparison with subsequent video frames. The process continues until all of the video frames have been exhausted. As previously discussed, the object trajectory list could be a table, and/or a temporary storage area in the processor which is later stored, for example, on a hard drive, writeable CD ROM, tape, non volatile electronic storage, etc. Various modifications may be made on the present invention by a person of ordinary skill in the art that would not depart from the spirit of the invention or the scope of the appended claims. For example, the type of method used to identify the object in the video frames, the threshold values provided by which storage of additional coordinates and subsequent frames is determined, may all be modified by the artisan in the spirit of the claimed invention. In addition, a time interval could be introduced into the process, where for example, after a predetermined amount of time, the coordinates of a particular frame are stored even if a predetermined threshold of motion is not reached. Also, it is within the spirit of the invention and the scope of the appended claims, and understood by an artisan that that coordinates other than x and y could be used, (for example, z) or, the x,y coordinates could be transformed into another space, plane or coordinate system, and the measure would be done in the new space. For example, if the images were put through a perspective transformation prior to measuring. In additio, the distance measured could be other than Euclidian distance, such as a less-compute-intensive measure, such as |xnew−xref|+|ynew−yref|≧ε.

What is claimed is:

1. A method for storing a trajectory of tracked objects in a video, comprising the steps of:
(a) identifying objects in a first video frame;
(b) determining first reference coordinates (xrefᵢ,yrefᵢ) for each of said objects identified in step (a) in the first video frame;
(c) storing the first reference coordinates (xrefᵢ,yrefᵢ);
(d) identifying said objects in a second video frame;
(e) determining current reference coordinates (xnewᵢynewᵢ) of said objects in said second video frame; and
(f) storing the current reference coordinates of a particular object in an object trajectory list and replacing the first reference coordinates (xrefᵢ,yrefᵢ) with the current reference coordinates (xnewᵢynewᵢ) if the following condition for the particular object is satisfied:
∥(xnewᵢ,ynewᵢ)−(xrefᵢ,yrefᵢ)∥²≧ε,
wherein ε is a predetermined threshold amount, and
retaining the first reference coordinates (xrefᵢ,yrefᵢ) for comparison with subsequent video frames when said condition is not satisfied.

2. The method according to claim 1, further comprising:
(g) repeating steps (e) and (f) for all video frames subsequent to said second video frame in a video sequence so as to update the storage area with additional coordinates and to update the current reference coordinates with new values each time said condition in step (f) is satisfied.

3. The method according to claim 1, wherein when said condition step (f) is not satisfied, storing the current coordinates of the particular object as final coordinates of a final frame of said subsequent video frames in the video sequence.

4. The method according to claim 1, further comprising:
although said condition in step (f) has not been satisfied, storing the current coordinates as final coordinates before the particular object disappears and a trajectory ends from the subsequent video frames in the video sequence.

5. The method according to claim 1, wherein the object trajectory list for the particular object stored in step (f) comprises a temporary memory of a processor, and
(h) writing the object trajectory list to permanent storage from all the coordinates stored in the temporary memory after all the frames of the video sequence have been processed by steps (a) to (g).

6. The method according to claim 5, wherein the permanent storage comprises at least one of a magnetic disk, optical disk, magneto-optical disk, and tape.

7. The method according to claim 5, wherein the permanent storage is arranged in a network server.

8. The method according to claim 1, wherein determination of the current reference coordinates (xnewᵢ,ynewᵢ) in step (e) includes size tracking of the objects moving one of (i) substantially directly toward, and (ii) substantially directly away from a camera by using a box bounding technique.

9. The method according to claim 2, wherein determination of the current reference coordinates (xnewᵢ,ynewᵢ) in step (e) includes size tracking of the objects moving one of (i) substantially directly toward, and (ii) substantially directly away from a camera by using a box bounding technique.

10. The method according to claim 5, wherein determination of the current reference coordinates (xnewᵢ,ynewᵢ) in step (e) includes size tracking of the objects moving one of (i) substantially directly toward, and (ii) substantially directly away from a camera by using a box bounding technique.

11. The method according to claim 8, wherein the box bounding technique comprises:
(i) determining a reference bounding box (w_{ref},h_{ref}) of the particular object, wherein w represents a width, and h represents a height of the particular object;
(ii) storing a current bounding box (wᵢ,hᵢ) if either of the following conditions in substeps (ii) (a) and (ii) (b) are satisfied:

|wᵢ−wrefᵢ|>δ_{w}; (ii) (a)

|hᵢ−hrefᵢ|>δₕ. (ii) (b)

12. The method according to claim 8, wherein the determination of whether current reference coordinates has reached a threshold ε includes a combining of the box bounding technique and differences in (xnewᵢ,ynewᵢ) and (xrefᵢ, yrefᵢ).

13. The method according to claim 10, wherein the box bounding technique comprises:
(i) determining a reference bounding box (w_{ref},h_{ref}) of the particular object, wherein w represents a width, and h represents a height of the particular object;
(ii) storing a current bounding box (wᵢ,hᵢ) if either of the following conditions in substeps (ii) (a) and (ii) (b) are satisfied:

|wᵢ−wrefᵢ>δ_{w}; (ii) (a)

|hᵢ−hrefᵢ>δₕ. (ii) (b)

14. The method according to claim 11, wherein the box bounding technique comprises:
(i) determining a reference bounding box (wrefᵢ,hrefᵢ) of the particular object, wherein w represents a width, and h represents a height of the particular object; (ii) storing a current bounding box (wᵢ,hᵢ) if either of the following conditions in substeps (ii) (a) and (ii) (b) are satisfied:

|wᵢ−wrefᵢ>δ_{w}; (ii) (a)

|hᵢ−hrefᵢ>δₕ. (ii) (b)

15. The method according to claim 9, wherein the box bounding technique comprises:
(i) determining an area a=wrefᵢ*hrefᵢ of a reference bounding box (wrefᵢ,hrefᵢ) of the particular object, wherein w represents a width, and h represents a height of the particular object; and
(ii) storing coordinates of a current bounding box (wᵢ,hᵢ) if a change in area δₐ of the current bounding box is greater than a predetermined amount.

16. The method according to claim 10, wherein the box bounding technique comprises:
(i) determining an area a=wrefᵢ*hrefᵢ of a reference bounding box (wrefᵢ,hrefᵢ) of the particular object, wherein w represents a width, and h represents a height of the particular object; and
(ii) storing coordinates of a current bounding box (wᵢ,hᵢ) if a change in area δₐ of the current bounding box is greater than a predetermined amount.

17. The method according to claim 11, wherein the box bounding technique comprises:
(i) determining an area a=wrefᵢ*hrefᵢ of a reference bounding box (wᵢ,hᵢ) of the particular object, wherein w represents a width, and h represents a height of the particular object; and
(ii) storing coordinates of a current bounding box (wᵢ,hᵢ) if a change in area δₐ of the current bounding box is greater than a predetermined amount.

18. The method according to claim 1, wherein the predetermined threshold amount ε of the particular object is dynamically computed according to one of average object velocity, size of the particular object, and designation of a degree of importance of the particular object.

19. A system for storage of the trajectory of tracked objects in a video, comprising:
a processor;
a video input for providing images to the processor;
a video content analysis module for tracking coordinates of objects in the images provided to the processor; and
means for storage of object trajectories;
wherein the video content module assigns a reference coordinate value to each object identified in a first reference frame of the images, and updates the reference coordinate value to a value of a subsequent frame only when an amount of motion of the object in the subsequent frame relative to the first frame exceeds a threshold from the reference coordinate value.

20. The system according to claim 19, wherein the video content analysis module initiates storage of the reference coordinates of the subsequent frame as part of a trajectory path of the motion of the particular object.

21. The system according to claim 19, wherein the video content module includes a box-bounding function for identifying a width and height of the particular objects.

22. The system according to claim 21, wherein the video content analysis module updates reference coordinates when a predetermined change in one of size and area of the particular object has been detected by the box bounding.

23. The system according to claim 19, wherein the video input comprises a camera.

24. The system according to claim 19, wherein the video input comprises one of a video server, digital video disk, and videotape.

25. A method for storing a trajectory of tracked objects in a video, comprising the steps of:
(a) identifying objects in a first video frame;
(b) determining first reference coordinates (xrefᵢ,yrefᵢ) for each of said objects identified in step (a) in the first video frame;
(c) storing the first reference coordinates (xrefᵢ,yrefᵢ);
(d) identifying said objects in a second video frame;
(e) determining current reference coordinates (xnewᵢynewᵢ) of said objects in said second video frame; and
(f) storing the current reference coordinates of a particular object in an object trajectory list and replacing the first reference coordinates (xrefᵢ,yrefᵢ) with the current reference coordinates (xnewᵢynewᵢ) if the following condition for the particular object is satisfied:

|xnewᵢ−xrefᵢ|+|ynewᵢ−yrefᵢ≧ε;
wherein ε is a predetermined threshold amount, and
retaining the first reference coordinates (xrefᵢ,yrefᵢ) for comparison with subsequent video frames when said condition is not satisfied.
